(19) United States
(12) Patent Application Publication
(10) Pub. No.: US 2022/0227026 A1
(43) Pub. Date: Jul. 21, 2022

(54) DIPPING FORMER

(71) Applicant: DSM IP ASSETS B.V., Heerlen (NL)

(72) Inventors: Pim Gerard Anton JANSSEN, Echt (NL); Ruud Joseph Hubertus HAWINKELS, Echt (NL)

(21) Appl. No.: 17/623,059

(22) PCT Filed: Jun. 25, 2020
(86) PCT No.: PCT/EP2020/067818

§ 371 Date: Dec. 27, 2021

(30) Foreign Application Priority Data
Jun. 28, 2019 (EP) 19183265.8
Mar. 27, 2020 (EP) 20166156.8

(51) Int. Cl. B29C 33/38; B29C 41/40; B29C 41/14; B29C 33/40

(52) U.S. Cl. CPC B29C 33/3842; B29C 41/40; B29L 2031/4864; B29C 33/40; B29C 41/14

(57) ABSTRACT

The disclosure relates to a dipping former, to a process for producing the dipping former and to the use of the dipping former in a latex dipping process. The dipping comprises (i) a molded core part, and (ii) a dipping former shell having a surface in one piece. The dipping former is obtainable by a molding process comprising the following steps: —providing a first cavity and a second cavity; —injection molding or blow molding a first material into the first cavity thereby forming a molded core; —transferring the molded core form the first cavity into the second cavity; and —injection molding of a second material into the second cavity thereby overmolding the molded core, or at least a part thereof, with the second material.

The present invention relates to a dipping former, to a process for producing the dipping former and to the use of the dipping former in a latex dipping process.

### INTRODUCTION

A dipping former is a structural member which models a shape of an object and enables the formation of a dip-molded article corresponding to the shape of the object. The dip-molded article can be made by a so-called dipping process. In such a process, the dipping former is dipped or immersed into a polymer emulsion, suitably being a rubber latex or a vinyl polymer emulsion, and polymer particles in the emulsion, more particularly rubber particles in the latex, coalesce and produce a coherent polymer film on the dipping former. The film will be in the shape of the dipping former. In its simplest form, dipping is a process in which a thin-walled polymer (usually rubber) products are produced by first immersing a former in a polymer emulsion or rubber latex which has been suitably compounded, and then subsequently slowly withdrawing the former from the emulsion or latex in such a way as to leave a uniform deposit upon the former. The thickness of the deposit can be increased if desired by repetition of the dipping and coalescence step. The formation of the product is completed by leaching, drying and, if necessary, subjecting it to appropriate treatments, of which the most obvious is vulcanization of the rubber. The product may also be subjected to appropriate post-treatments. In many cases, it is the practice to form a rolled bead at the open end(s) of the article. The purpose of the bead is principally to reinforce the thin film against tear-initiation from the edge of the open end. It also prevents very thin-walled articles from adopting various distorted configurations. The product is usually removed from the former before use. Products manufactured as described above can be defined as unsupported because such strength as the product possesses is attributable entirely to the polymer itself. Latex dipping is also used to manufacture so-called supported products, in which the strength of the product is primarily derived from a fabric lining upon which the polymer film is deposited. Such products are produced by first placing the liner upon the former, and then applying the polymer film by a latex-dipping process.

The finishing or surface texture of the dipping former may be textured or smooth to produce a consistently even-surfaced dip-molded article without any surface irregularities or indentations. As the retail price of dip-molded articles is generally low, the production cost must be kept at a minimum to achieve a desirable profit. Thus, the production cost of a former must be kept low and the former should provide long term reusability to allow for a large number of production cycles to increase cost effectiveness.

For the manufacturing of dipping formers traditionally heavy and fragile materials, such as ceramic, porcelain and glass are commonly used. Plastic is becoming an alternative to these materials. Among possible plastic materials, PPS and polyamide are mostly considered.

The articles produced with the said dipping forming process can be, for example, thermoplastic polymer articles, such as, for example, vinyl polymer based articles, and thermoset or cured articles, such as, for example, vulcanized rubber based articles.

The most extensive use of dipping formers in production of dip-molded articles by a dipping process is for the production of rubber gloves. Such dipping formers are also known as glove dipping formers or hand formers, as these formers typically have the general shape of a hand.

### DESCRIPTION OF PRIOR ART

Generally, plastic glove dipping formers are typically manufactured in separate portions prior to joining them together. Injection molding is the most commonly used manufacturing process for the fabrication of plastic parts. In injection molding, the shape and configuration of the molds including the mold insert must be carefully considered. This is in particular the case with complex three-dimensional hollow products. This also applies for plastic glove dipping formers. Firstly, the mold must allow for removal of the molded article as well as removal of the mold insert after the molten plastic solidifies i.e. any undercut formed must not be blocking the removal of either the molded article or mold insert. As such, products manufactured by injection molding are usually made in separate portions which are later joined together to complete the final product.

There are inherent difficulties in joining together the separate portions of dipping formers made of PPS and this causes obvious defects in parting lines, uneven joints and/or weak seams. This is not desirable as the uneven surface areas resulting hereof will cause defects in the rubber article produced and/or the weak joint will shorten the life span and decrease reusability of the dipping former. Material selection and the manufacturing process have an impact on the parting lines, uneven joints and/or weak seams.

Malaysian utility innovation application no. UI 2016700796 discloses a method of manufacturing a glove dipping former from several molded parts by injecting molding. A metal mold used in this method consists of an outer mold having a cavity corresponding to the overall shape of the intended dipping former and a mold insert which is smaller in size but corresponds to the shape of the respective mold. The outer mold defines a cavity to form the exterior shape of a molded part of the dipping former whereas the mold insert defines an inner cavity of the molded part of the dipping former. There are no difficulties in joining the molded parts together when using this method. However, like all articles manufactured by injection molding, excess material at the edges of the molded parts have to be trimmed away before the mating ends are annealed and welded together. Besides that, if a counter weight is required, the counter weight has to be inserted before the molded parts are welded together. Further, excess material flashed outwards from the seam after the welding process needs to be trimmed away. Therefore, there are additional laborious steps that have to be taken if a dipping former consists of several molded parts.

Malaysian utility innovation application no. UI 20170001230 discloses a method of manufacturing a glove dipping former in one single piece using a collapsible core. Due to the complex shape of a glove dipping former the collapsible core is not able to create a homogeneous cavity width over the whole former, especially in the finger and top of the hand palm. In injection molding the inhomogeneous and large thickness leads to productivity losses, long cycle times and surface defects on the glove dipping former. Surface defects like sink marks, discolorations or surface roughness anomalies have a negative effect on the glove quality.

The present invention aims to provide a dipping former that allows for improving producibility of the dipping former while securing the quality of the rubber article obtained from the dipping process using said dipping former. The present invention in particular aims to provide a glove dipping former that allows for improving producibility of the glove dipping former while securing the quality of the rubber article obtained from the dipping process using said dipping former.

### SUMMARY OF THE INVENTION

According to the current invention there is provided
a dipping former production process resulting in a dipping former having a dipping-surface-in-one-piece;
a dipping former having a surface-in-one-piece; and
a dipping process for making a rubber article comprising the use of the dipping former having a surface-in-one-piece.

In a preferred embodiment thereof, the dipping former is a glove dipping former.

The process for producing the dipping former is a molding process comprising steps of
providing a first cavity and a second cavity, wherein the first cavity is smaller than the second cavity;
injection molding or blow molding of a first material into the first cavity thereby forming a molded core;
transferring the molded core form the first cavity into the second cavity;
injection molding of a second material into the second, thereby overmolding the molded core, or at least a part thereof, with the second material and forming a dipping former comprising (i) a molded core part and (ii) a shell having a surface in one piece.

The first cavity is used for forming the core of the dipping former and can therefore also be referred to as core cavity. The second cavity is used for forming the outer or final shape of the dipping former and can therefore also be referred to as dipping former cavity or shell cavity. The shape of the core cavity is such that the core part molded in the first cavity, fits in the second mold, or at least for an essential part thereof, and can be fitted and positioned inside the second mold, such as to leave space for overmolding the core part, or at least for the essential part thereof, with the second material. By fitting and positioning at least an essential part of the molded core inside the second mold, allows for the overmolding of at least a part of the molded core with the second material. The material that is injected first and used to form the molded core can therefore also be referred to as core material. The material that is injected second and used for forming the shell of the dipping former can therefore also be referred to as shell material. With the ‘dipping-surface-in-one-piece’ is herein understood that the dipping former has a surface part intended for being dipped or immersed during the dipping process and that that surface part is integrally molded in one injection shot and therefore does not have a seam or weld line.

The advantages of the process according to the invention for the production of a dipping former by the described two-step injection molding process, comprising firstly forming a molded core followed by forming a shell overmolded over the molded core, are that the dipping former has a dipping-surface-in-one-piece, no welding is needed and therefore no need to trim away excess material flashed outwards from a welded seam, with the dipping former being formed in one part, i.e. without welding, the reusability of the dipping former and its lifespan is enhanced compared to dipping formers made from assembled or welded two-halves, removal of the molded article, even despite possible complex 3-dimensional shapes, the use of a complex collapsible core is avoided, uneven surface areas and tracks of welded seams, and traces and defects resulting thereof in the rubber article are avoided, and overmolding of the core prevents large pockets in the dipping former cavity, which otherwise would lead to productivity losses, and allows for a homogeneous melt flow in the cavity, thereby reducing or eliminate sink marks, discolorations and anomalies on the surface of the dipping former.

In the present invention the dipping former is obtained by providing material in different cavities in multiple molding steps. One injection or blow molding cycle is used for the production of the molded core. A second injection cycle is required for creating the external surface area of the dipping former intended for contact with the dipped product. This requires a chemical resistant and long-lasting material. Other injection cycles can be added to create functional elements like color coding, reducing weight or attaching mechanisms to the dipping line.

This allows to select multiple materials, each able to optimize towards the requirements of the specific area it is provided in.

The core material, i.e. the material of which the molded core is made, and the shell material, i.e. the material of which the shell is made, may or may not be equal, i.e. the material of the molded core may differ from the material of the shell by e.g. chemical composition, chemical structure, chemical and/or physical properties. Using different materials for the core and the shell allows more freedom of design of the dipping former making it suitable for different applications in industry due to the fact that different functionalities can be introduced in the core and shell materials, this resulting in different properties of the core and the shell and thus of the dipping former. Using different materials for the core and the shell also allows optimizing the weight of the dipping former by adjusting the composition of the core material, while the shell material can be chosen to preference or need for the surface properties of the dipping former. An additional advantage of adjusting the core material is the reduction of costs of the dipping former while retaining the high performance costly dipping former shell material.

The molded core material (i.e. the first material) can be any thermoplastic polymer known in the art. The thermoplastic polymers can be chosen depending on the desired design of the dipping former and for a specific application. The thermoplastic polymers are preferably semi-crystalline thermoplastic polymers and may include, but are not limited to, polyethylene, polypropylene, polyolefins, polyamides, polyesters, polycarbonates, polysulfones, polyacetals, polylactones, acrylonitrile-butadiene-styrene resins, polyphenylene oxide, polyphenylene sulfide, styrene acrylonitrile resins, styrene maleic anhydride, polyimides, aromatic polyketones, or mixtures of two or more of the above. More preferably, the thermoplastic polymers have a melting temperature (Tm) of at least 100° C., preferably of at least 150° C. or a glass transition temperature (Tg) of at least 200° C., with Tm and Tg being measured by differential scanning calorimetry (DSC) at a heating rate of 10° C./min. Also preferred as molded core material are thermoplastic polymers that are chemical resistant, preferably chemically resistant against acid and base substances in water at a temperature equal with or higher than 70° C.

Suitably, the shell material (i.e. the second material) is selected from a polyamide based composition, i.e. a composition comprising polyamide, or a PPS based composition, i.e. a composition comprising PPS, or a polyketone based composition.

The process for producing the dipping former having a dipping-surface-in-one-piece according to the invention can be carried out by applying the following steps:
providing the first cavity for forming the molded core and the second cavity for forming the dipping former;
injection molding or blow molding of an amount of the first material into the first cavity thereby forming the molded core;
transferring the molded core form the first cavity into the second cavity;
injection molding of an amount of the second material (dipping former shell material) into the second cavity thereby overmolding the molded core, or at least a part thereof, with the second material and forming a dipping former comprising (i) the molded core part and (ii) the dipping former shell, the dipping former thus having a dipping surface in one piece.

In a preferred embodiment of the process according to the invention the molded core is connected to a retractable insert before being provided in the glove dipping former cavity. More preferably, the retractable core is provided into the first cavity and the first material is injection molded into the first cavity and molded over the retractable core, thereby forming the molded core connected to the retractable core. In comparison to a collapsible core, a retractable and/or overmolded core has lower technical complexity which makes this a cost competitive technology.

In another preferred embodiment of this invention the dipping former is a glove dipping former. The main areas of the glove dipping former are the fingers, crotch, palm, wrist and forearm. Preferably, in the process according to the invention, the second material is overmolded over the molded core at least in areas for forming fingers, crotch, palm, wrist and forearm.

The dipping former produced with the process according to the invention comprises (i) a molded core part and a (ii) dipping former shell having a dipping surface in one piece. Herein the molded core may be overmolded only partly such that the molded core extends beyond the overmolded shell. This has the advantage that the dipping former has a larger overall integral strength. Furthermore, it is more suitable for integration of accessories; and allows for further cost reduction. In an alternative embodiment, the molded core may be overmolded completely in such a way that the overmolded shell extends beyond the molded core. More preferably, the core material used herein has a higher density that the shell material. This has the advantage that weight balance of the dipping former can be shifted more easily to the front end of the dipping former, thereby improving the buoyancy characteristics of the dipping former and improving the dipping and cleaning process. Furthermore, there is more flexibility in the choice of the core material, which may be less chemical resistant, since the core will be not be in contact with cleaning liquids during the cleaning process.

In the production of dipped articles, the formers need to be mounted onto a dipping chain. The mounting should be easy and reversibly to allow for regular cleaning and remounting. In a special embodiment of the invention the dipping former is provided with a mounting element. In one preferred embodiment, the dipping former comprises a mounting element integrally molded with the molded core. This embodiment is favorably combined with the molded core extending beyond the overmolded shell. In another preferred embodiment, the dipping former comprises a mounting element integrally molded with the overmolded shell. This embodiment is favorably combined with the overmolded shell extending beyond the molded core.

Suitably, the mounting element is, for example, a snap-fit element, a screw thread, or a bayonet fitting element.

The present invention also relates to a dipping former comprising (i) a molded core part and a (ii) dipping former shell having a dipping surface in one piece, as described herein. Preferably, the dipping former comprises (i) a molded core part and a (ii) dipping former shell having a dipping surface in one piece, wherein the material of which the molded core is made is different than the material of which the shell is made. More preferably, the dipping former comprises (i) a molded core part and a (ii) dipping former shell having a dipping surface in one piece, wherein the material of which the molded core is made is different than the material of which the shell is made and the mold is retractable.

The present invention also relates to a dipping former obtainable by a multiple step molding process, comprising (i) a molded core part, and (ii) a dipping former shell having a surface in one piece, and the various embodiments thereof as described herein above. Particularly preferable, the dipping former is a glove dipping former.

The present invention also relates to the use of a dipping former according to the invention in a latex dipping process for making a rubber article.

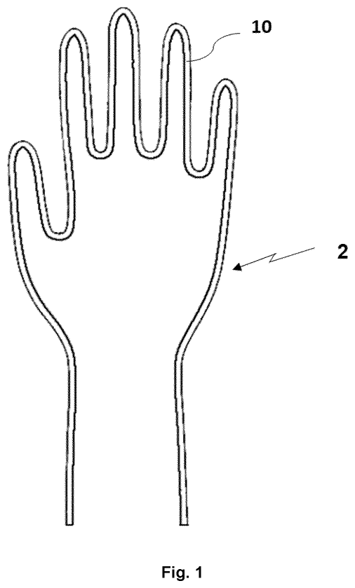

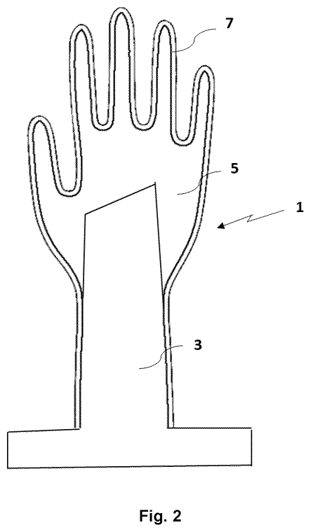

Figures: the invention is further illustrated with the following figures. FIG. 1 shows a schematic cross section of a conventional dipping former. FIGS. 2-7 show schematic cross sections of different embodiments of the dipping former according to the present invention.

FIG. 1 shows a schematic cross section of a conventional dipping former (2) consisting of a shell (10). The conventional dipping former (2) can be made by a conventional process, for example in two parts, which are combined afterwards to constitute the dipping former. The complex internal space of the mold prevents the use of a retractable mold and making the shell (10) in one piece.

FIG. 2 shows a schematic cross section of a dipping former (1) produced with the process according to the present invention. The figure shows the dipping former (1) with a retractable mold (3) still retained therein. In the process according to the invention, the dipping former (1) can be easily removed from the retractable mold (3). The dipping mold (1) comprising a molded core part (5), which has been molded over a part of the retractable mold (3), and a dipping former shell (7), which has been molded over the molded core part (5) and the retractable mold (3). The shell has a surface in one piece.

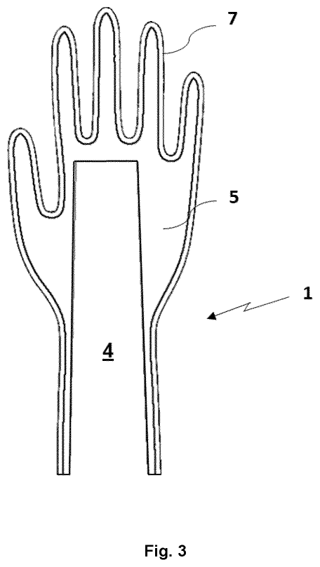

FIG. 3 shows a schematic cross section of an embodiment of a dipping former according to the present invention, removed from a retractable mold. The dipping former (1) comprises a molded core part (5) and a dipping former shell (7). The removal of the retractable mold has left an open space (4). The shell (7) has a surface in one piece fully covers the molded core part (5).

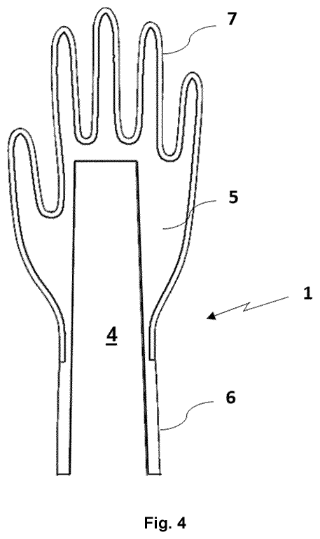

FIG. 4 shows a schematic cross section of an embodiment of a dipping former according to the present invention, removed from a retractable mold. The dipping former (1) comprises a molded core part (5) and a dipping former shell (7). The removal of the retractable mold has left an open space (4). The shell (7) has a surface in one piece. The shell (7) covers the molded core part (5) partly, thus leaving a part (6) of the molded core part (5) uncovered.

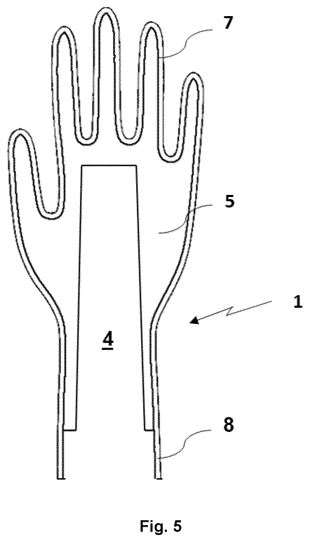

FIG. 5 shows a schematic cross section of an embodiment of a dipping former according to the present invention, removed from a retractable mold. The dipping former (1) comprises a molded core part (5) and a dipping former shell (7). The removal of the retractable mold has left an open space (4). The shell (7) has a surface in one piece. The shell (7) covers the molded core part (5) and extends beyond the molded core part (5) by an extending part (8).

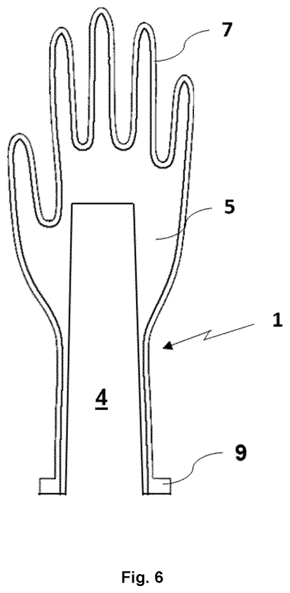

FIG. 6 shows a schematic cross section of an embodiment of a dipping former according to the present invention, removed from a retractable mold. The dipping former (1) comprises a molded core part (5) and a dipping former shell (7). The removal of the retractable mold has left an open space (4). The shell (7) has a surface in one piece. The shell (7) covers the molded core part (5) and comprises integrally molded mounting elements (9).

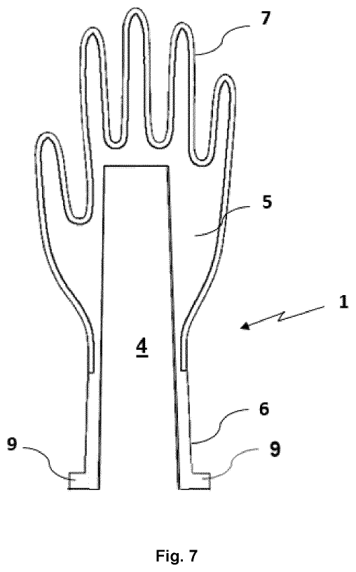

FIG. 7 shows a schematic cross section of an embodiment of a dipping former according to the present invention, removed from a retractable mold. The dipping former (1) comprises a molded core part (5) and a dipping former shell (7). The removal of the retractable mold has left an open space (4). The shell (7) has a surface in one piece. The shell (7) covers the molded core part (5) partly, thus leaving a part (6) of the molded core part (5) uncovered. The molded core part (5) comprises integrally molded mounting elements (9).

The dipping former according to the present invention and the various embodiments thereof can be produced in a two-step process, wherein the production of the core part and the production of the shell part are carried out as sequential steps in the same molding machine. The dipping former according to the present invention and the various embodiments thereof can also be produced in a two-step process, wherein the core part is produced in a first molding machine, after which the core is transferred to another molding machine wherein the core is overmolded and the shell part is produced.

1. Process for producing a dipping former, the process being a molding process comprising the following steps:
providing a first cavity and a second cavity;
injection molding or blow molding a first material into the first cavity thereby forming a molded core;
transferring the molded core form the first cavity into the second cavity;
injection molding of a second material into the second cavity thereby overmolding the molded core, or at least a part thereof, with the second material and forming a dipping former comprising (i) a molded core part and a (ii) dipping former shell constituting a dipping surface in one piece.

2. Process according to claim 1, wherein the molded core is connected to a retractable insert before being provided in the dipping former cavity.

3. Process according to claim 1, wherein the first material is different than the second material.

4. Process according to claim 1, wherein the first material is a thermoplastic polymer.

5. Process according to claim 1, wherein the second material is selected from a group consisting of a polyamide based composition, a PPS based composition and a polyketone based composition.

6. Process according to claim 1, wherein a retractable core is provided into the first cavity and the first material is injection molded into the first cavity and molded over the retractable core, thereby forming the molded core connected to the retractable core.

7. Process according to claim 1, wherein the dipping former is a glove dipping former.

8. Process according to claim 1, wherein the second material is overmolded over the molded core at least in areas for forming fingers, crotch, palm, wrist and forearm.

9. Process according to claim 1, wherein the dipping former is overmolded only partly such that the molded core extends beyond the overmolded shell.

10. Process according to claim 1, wherein the dipping former is overmolded completely such that the overmolded shell extends beyond the molded core.

11. Process according to claim 1, wherein the dipping former is provided with a mounting element.

12. Dipping former obtainable by a multiple step molding process as described in claim 1, comprising (i) a molded core part, and (ii) a dipping former shell having a surface in one piece.

13. Dipping former according to claim 12, obtained with a molding process employing a retractable core in the first molding step.

14. Dipping former according to claim 12, being a glove dipping former.

15. Use of a dipping former obtainable by the process of claim 12 in a latex dipping process for making a rubber article.
